(19) United States
(12) Patent Application Publication
(10) Pub. No.: US 2026/0300690 A1
(43) Pub. Date: Oct. 1, 2026

(54) SYSTEMS AND METHODS FOR ARTIFICIAL INTELLIGENCE AGENTS FOR MULTI-TURN INTERACTIONS

(71) Applicant: Salesforce, Inc., San Francisco, CA (US)

(72) Inventors: Akshara Prabhakar, Palo Alto, CA (US); Zuxin Liu, Palo Alto, CA (US); Weiran Yao, Palo Alto, CA (US); Jianguo Zhang, San Jose, CA (US); Ming Zhu, Palo Alto, CA (US); Shelby Heinecke, San Francisco, CA (US); Huan Wang, Palo Alto, CA (US)

(21) Appl. No.: 19/298,817

(22) Filed: Aug. 13, 2025

Related U.S. Application Data
(60) Provisional application No. 63/778,222, filed on Mar. 26, 2025.

(51) Int. Cl. G06N 3/045

(52) U.S. Cl. CPC G06N 3/045

(57) ABSTRACT

Embodiments described herein provide a method for multi-turn generation by an AI agent. The method includes: receiving, by a first neural network based language model, a set of context data including one or more APIs for performing actions, one or more domains, and one or more domain-specific policies; generating, by the first neural network based language model, a multi-turn task including a tuple of (task intent, groundtruth actions, groundtruth outputs); generating, by a second neural network based language model, one or more outputs in response to one or more user questions simulated based on the task intent; and executing, by the second neural network based language model, actions in response to the user questions. The method also includes: forming a training tuple including the user questions, the outputs, and the actions in response to the outputsare consistent with the groundtruth outputs and the actions are consistent with the groundtruth actions.

### CROSS REFERENCE(S)

The instant application is a nonprovisional of and claims priority under 35 U.S.C. 119 to U.S. provisional application No. 63/778,222, filed Mar. 26, 2025, which is hereby expressly incorporated by reference herein in its entirety.

### TECHNICAL FIELD

The embodiments relate generally to machine learning systems for generative artificial intelligence (AI), and more specifically to systems and methods for AI agents for AI multi-turn interactions.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task. However, training data for AI agents to perform multi-turn tasks is scarce and expensive to collect.

### BRIEF DESCRIPTION OF THE DRAWINGS

FIG. 1 illustrates an exemplary application of an AI agent, according to some embodiments.

FIG. 2A shows a simplified diagram illustrating a multi-turn enhancement framework, according to some embodiments.

FIGS. 2B and 2C show simplified diagrams illustrating data pipelines in a multi-turn enhancement framework, according to some embodiments.

FIG. 3A is a simplified diagram illustrating a computing device implementing the multi-turn enhancement framework described in FIGS. 1, 2A-2C, according to some embodiments.

FIG. 3B is a simplified diagram illustrating a neural network structure, according to some embodiments.

FIG. 4 is a simplified block diagram of a networked system suitable for implementing the multi-turn enhancement framework described in FIGS. 1, 2A-2C, 3A, and 3B and other embodiments described herein.

FIGS. 5A and 5B show an example logic flow diagram illustrating a method for multi-turn generation based on the framework shown in FIGS. 2A-2C, 3A, 3B, and 4, according to some embodiments.

FIGS. 6A-6G provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

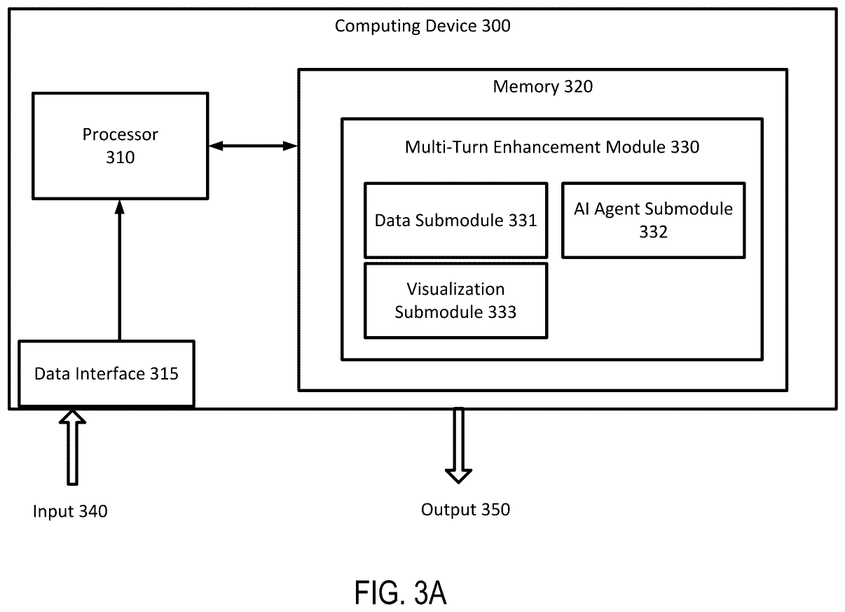

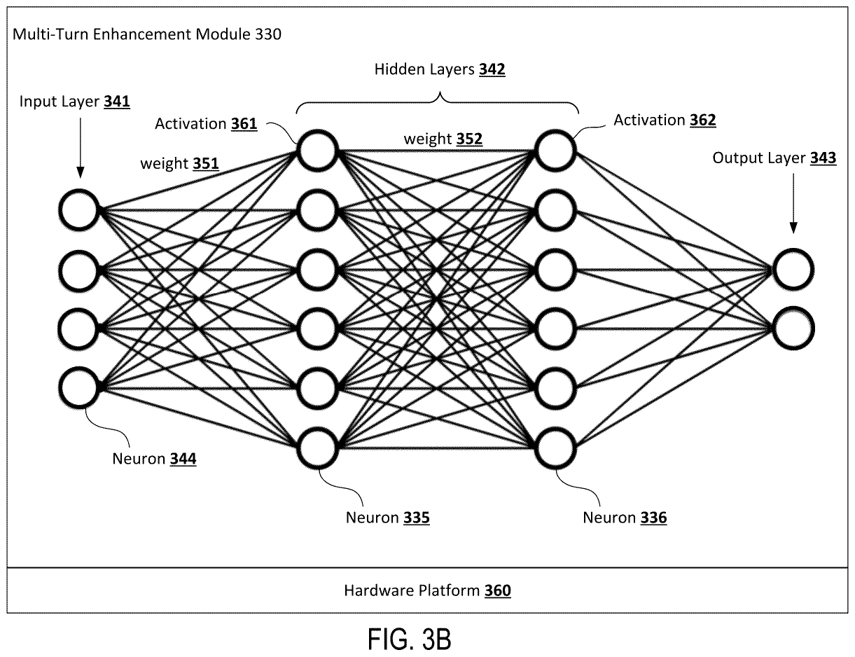

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 3B.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

Large language model (LLM) can be used for generating answers to natural language queries. However, AI agents based on LLMs may lack the ability to perform tasks involving multi-turn interactions, which refers to as a conversation that involves multiple exchanges (e.g., turns) between a user and the AI agent for the AI agent to generate the final answer to the user's question. For example, existing LLMs still fail to complete multi-turn interactions involving complex function calls, track long-term dependencies, and/or request missing information. It thus is challenging for LLMs to perform multi-turn tasks, e.g., when user requested information needs several rounds of question and answers between the user and the AI agent, and/or the like.

In view of the need for training data for multi-turn interactions, embodiments of the present disclosure provide methods and systems to train an AI agent to conduct multiple exchanges with a user for generating a final answer using a synthetic training dataset including multi-turn conversations. Each training multi-turn conversation includes multiple rounds of user question, followed by one or more AI agent actions, and a final answer after the multiple rounds. To generate the synthetic training data, a data pipeline may comprise a LLM to generate validated tasks that include tuples of (task intent, groundtruth actions, groundtruth outputs). For example, LLM may first be prompted to generate a candidate task, and then the format and execution of the candidate task may be programically checked. Upon the checking of the results, the LLM may be prompted again to review the quality aspects of the candidate task. A candidate task that passes the check and review becomes a validated task.

Then, the LLM may be prompted to generate a simulated multi-turn conversation based on the task intent of the validated task, including multiple exchanges between a user and an AI agent, e.g., one or more questions from a user, one or more actions performed by an AI agent, and one or more outputs from the AI agent. The AI agent's actions and the outputs are compared to the groundtruth actions and groundtruth outputs. If the actions and the outputs are both consistent with the respective groundtruth, the conversation trajectory is considered successful and is added into the training dataset. The AI agent, trained to learn the actions and outputs in the conversation trajectories in the training dataset, can thus complete the multi-turn tasks more accurately.

Embodiments described herein provide a number of benefits. For example, the AI agent, trained using the training data provided in this disclosure, can be used in autonomous driving systems/applications to facilitate communication between a user and the autonomous driving system. The AI agent may generate commands to the autonomous driving system based on a user's request. In an example, the AI agent can conduct multiple rounds of conversation/communication with the autonomous driving system to obtain a result for the user's request. The training can help the AI agent to be more capable, providing service of improved reliability, efficiency. The AI agents can also be used in chatbots for fields such as healthcare, network issue support, etc. Therefore, with improved performance on AI agents for multi-turn interactions, neural network technology in autonomous driving, healthcare, network issue support, and the lick, is improved.

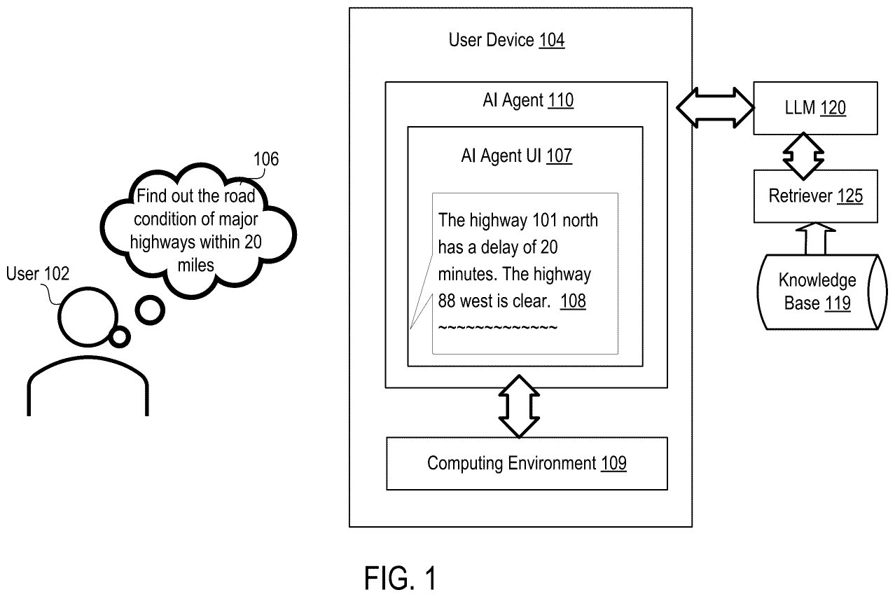

FIG. 1 shows an example operation of an LLM based AI agent, according to embodiments of the present disclosure. An LLM-based AI agent 110 may be implemented on a user device 104 to receive a user task request 106 as a natural language input, typically through a chat or command interface 107. This request 106 may range from simple queries to more complex tasks like data analysis, automation, or even generating content. For example, the user 102 may ask the AI agent to “Find out the road condition of major highways within 20 miles” 106.

In one embodiment, the AI agent 110 may process the task request 106 at an LLM 120 to understand its intent, extracting key information such as the task type, desired outcome, and any specific constraints in order to generate a response. The LLM 120 may be hosted at an external server, a cloud service, and/or the like that is accessible by a communication network. In a different implementation, the LLM 120 may be hosted on the user device 104, such as a robot, a Smartphone, an autonomous driving vehicle, etc. An input to the LLM 120 may comprise the task request 106 and instruction provided to the LLM 120 to guide its behavior or responses in a particular way, referred to as a “system prompt.” For example, the system prompt may contain instruction for the LLM 120 to analyze the input and respond according to the request identified in the input, and generate an output in a certain format, e.g., suggested code program, text description, etc. The LLM 120 may in turn generate a response 108 based on an input combining the task request 106, any system prompt, and additional information such as GPS location information of the user device 104. The LLM 120 may operate with a retriever model 125, which retrieves relevant context documents from a knowledge base 119 as a context, to in turn generate a textual response 108 based on an input combining the task request 106, any system prompt and the retrieved context. In some implementation, the knowledge base 119 may comprise an Internet data sources providing real-time traffic updates, weather reports, and road hazard information from connected services or cloud databases. Additional details on the LLM 120 generating output tokens to form the response 108 may be described in FIG. 3.

The response 108 may include instructions, explanations, code scripts or direct actions to address the task request 106. Such response 108 may be displayed via the AI agent interface 107 for transparency. In addition to the response 108 that describes how to fulfill the task request, the LLM 120 may generate computer-executable commands (e.g., system-level commands, Python scripts, etc.) that can directly trigger actions and/or interactions with the computing environment 109 on the user device 104.

For example, the LLM 120 may output a code script to execute on the computing environment 109 (such as a navigation application, a control application on an autonomous vehicle, etc.), on the user device 104 to retrieve traffic data and/or interface with APIs of other applications to retrieve traffic data, and/or the like. When the user device 104 is an autonomous driving vehicle, the generated code script may comprise system-level command, e.g., steering, acceleration, or braking commands—to adapt the vehicle's behavior. For example, if it detects heavy traffic or a road closure ahead, the system can calculate an alternate route and seamlessly adjust the steering and speed to follow the new path without requiring further human input.

In this way, the LLM-based AI agent may facilitate end-to-end workflow to automate the task request 106.

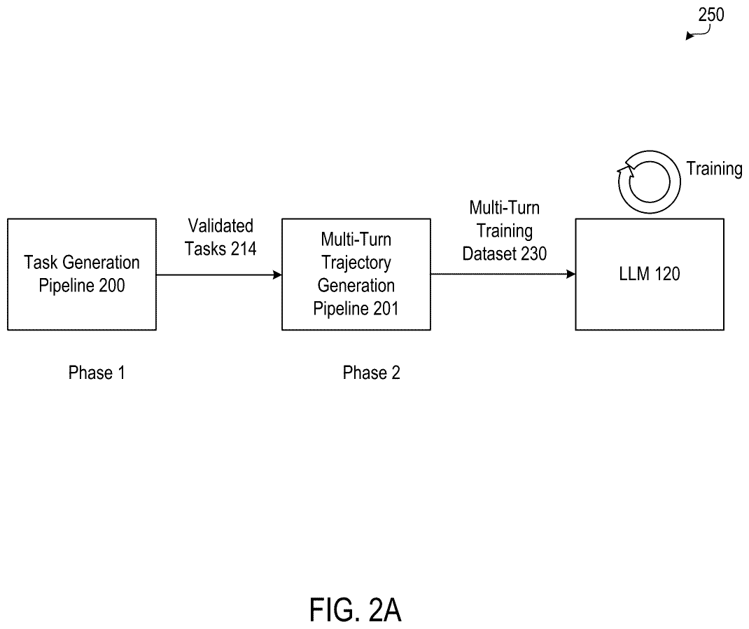

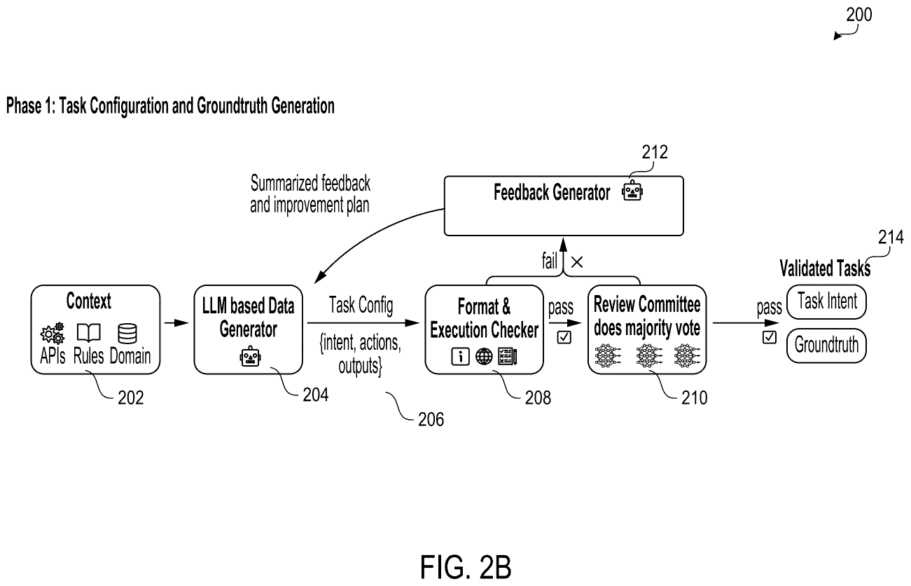

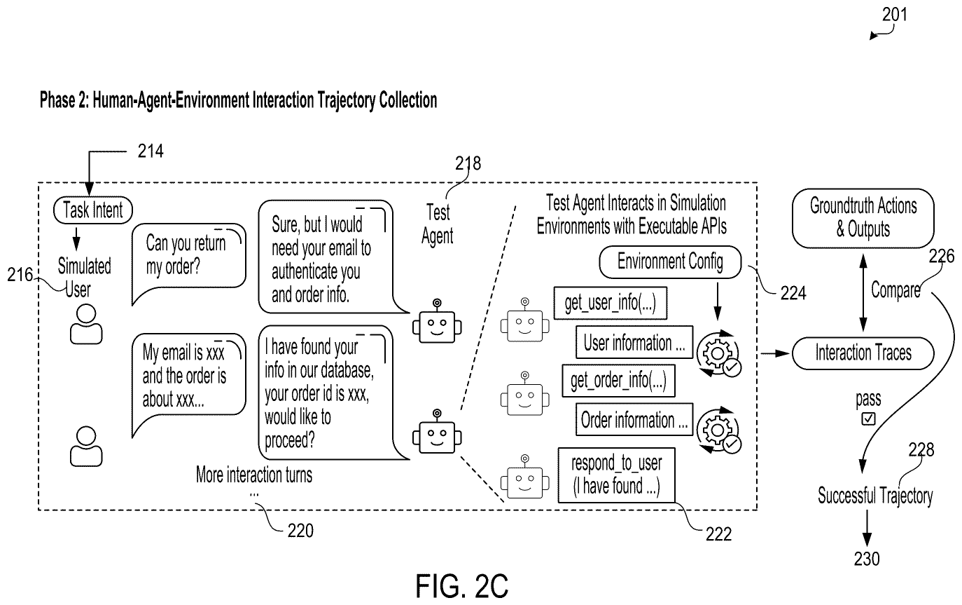

The AI conversational agent 110 may be widely used in various applications such as a customer service bot designed to handle multi-turn dialogues, comprising back-and-forth interactions with users 102 to resolve issues or answer questions. For example, in addition to just one user query 106, AI agent 110 may maintain context across multiple exchanges, remembering the user's previous messages to provide coherent and relevant responses. For example, if the user 102 asks about the status of an order and then follows up with a change request, the AI agent 110 may track the conversation flow, retrieve order details, and guide the user 102 through the modification process step by step. Thus, the underlying LLM 120 may be trained for multi-turn interactions to improve its performance, as further described in FIGS. 2A-2C, and 3 below.

Embodiments of the present disclosure provide a multi-turn enhancement framework configured to improve an AI agent's capability to process multi-turn conversations with humans (e.g., users). The multi-turn enhancement framework may include data pipelines to generate multi-turn training data for training an AI agent on multi-turn interactions. The AI agent trained using the multi-turn training dataset may have enhanced capability in processing multi-turn conversations, and may be used in various applications such as autonomous driving, healthcare, network issue diagnosis. For example, the AI agent may generate a command, based on a user request, to an autonomous driving system to perform various operations such as driving mode change, road condition reporting, etc.

FIG. 2A shows a multi-turn enhancement configured to generate the training data, and training LLM 120 using the generated training data, according to some embodiments. Specifically, a task generation pipeline 200 may be configured to generate a set of validated tasks 214, which may be processed by a multi-turn trajectory generation pipeline 201 to generate a multi-turn training dataset 230. LLM 120 may be trained on multi-turn training dataset 230. A trained LLM 120 may be used to build an AI agent.

In the description of multi-turn enhancement framework 250, multi-turn interactions between an AI agent and a human may be formalized as a Partially Observable Markov Decision Process (POMDP) defined by the tuple ( [symbol] ), where [symbol] represents the instruction space containing possible user intents; [symbol] denotes the state space of the environment and conversation history; [symbol] ={tool_call, response} is the action space available to the AI agent; [symbol] = [symbol] _{E}∪ [symbol] _{H} is the observation space comprising observations from the environment ( [symbol] _{E}) and response from the human ( [symbol] _{H}); [symbol] : [symbol] × [symbol] → [symbol] × [symbol] is the transition function; and R is the reward function evaluating interaction success. The AI agent may engage in dialogue to incrementally infer the user's intent q∈ [symbol] and solve it through appropriate interactions with the environment while adhering to any domain rules. At turn t, the AI agent may predict an action a^{t}∈ [symbol] based on the interaction history and understanding of q thus far. When a^{t} is a tool_call compliant with the rules, it may trigger a state transition

$$( {s}_{E}^{t} , too\_call ) \to ( {s}_{E}^{t + 1} , {o}_{E} ) ,$$

where o_{g} ∈ [symbol] _{E} is the tool output (typically in structured format like jSON). When a^{t} is a response to the human, it may cause a state transition

$$( {s}_{H}^{t} , response ) \to ( {s}_{H}^{t + 1} , {o}_{H} ) ,$$

where o_{H}∈ [symbol] _{H} is the human's follow-up message. Importantly, the environment state

$${s}_{E}^{t + 1}$$

may remain latent to both the AI agent and the human. The interaction terminates when the user sends a concluding message or a predefined turn limit is reached. The reward [symbol] (ΔS_{E}, a) may be calculated based on the cumulative state change in the environment ΔS_{E} and the sequence of responses a={aᵢ|aᵢ∈response to user} provided by the AI agent throughout the episode. The AI agent's objective is to maximize this reward.

Multi-turn enhancement framework 250 may include a two-phase framework for generating verifiable and diverse multi-turn data for training an AI agent. The two-phase framework may include an agentic feedback loop and a simulated human-agent interplay to generate realistic multi-turn conversations. An important aspect of multi-turn enhancement framework 250 is to separate the task generation process into two distinct phases: first creating a detailed “blueprint” of the task (Phase 1, by task generation pipeline 200), and then using this blueprint to guide the generation of realistic multi-turn interactions that fill in the conversational details (Phase 2, by multi-turn trajectory generation pipeline 201). This separation may improve both correctness of the underlying task structure and the naturalness of the resulting conversations.

In one embodiment, a pretrained LLM may be fine-tuned on the curated datasets specifically designed for multi-turn dialogues. For example, given a multi-turn dialogue training sample, the LLM may be fed with a window of several past turns as a training input, based on which the LLM may reference and thus interact with user input of subsequence turns to generate LLM-predicted answers/interactions. The ground-truth multi-turn trajectories may thus be compared with the LLM-predicted trajectory to compute a training loss. In cases where the conversation history is too long for the model's context window, older turns can be summarized or compressed. Additionally, fine-tuning often includes conditioning the model with role-specific instructions or persona tokens (e.g., “You are a helpful assistant”) to guide tone, style, and behavior consistently throughout the conversation.

In another embodiment, the LLM may be trained via reinforcement learning. For example, reinforcement learning techniques such as Reinforcement Learning from Human Feedback (RLHF) are applied to the LLM using the multi-turn training trajectories. In this setup, human evaluators rank multiple responses from the model based on qualities like helpfulness, accuracy, and coherence, which are then used to train a reward model. The LLM is optimized to maximize this reward signal, improving its ability to engage in natural, multi-turn conversations. This approach ensures that the model not only generates grammatically correct responses but also maintains context, exhibits conversational flow, and aligns with human preferences for tone and usefulness.

FIG. 2B shows a task generation pipeline 200 as part of multi-turn enhancement framework 250, according to some embodiments. Task generation pipeline 200 may perform operations in “Phase 1” of the multi-turn enhancement framework 250. For example, Phase 1 may include “task configuration and groundtruth generation”. Phase 1 of multi-turn enhancement framework 250 may generate a set of verified tasks 214 with well-defined task configurations. Each verified task may include a user intent (q), a corresponding sequence of verifiable groundtruth actions (a_{gt}), and the expected final outputs (o_{gt}). Phase 1 may establish a solid, verifiable foundation for each interaction scenario before the complexities of conversational dynamics are introduced. As depicted in FIG. 2B, this is achieved through an agentic workflow incorporating multi-stage validation and refinement loops.

At the beginning of the task generation, context data 202 is prepared. Context data 202 relevant to a candidate task to be generated may be assembled/prepared. Context data 202 may include one or more application programming interfaces (APIs), domain-specific rules and/or policies, and/or reference data. The APIs may include a set of rules and/or tools that allow an AI agent to call for certain functions, and receive results of the functions. In some embodiments, the APIs are sampled to include, e.g., only, state-changing (‘write’) APIs instead of sate-exploring (‘read’) APIs. The state-changing APIs, when called, may change the state of the executable environment. The APIs in context data 202 may be non-conflicting with one another. The domain-specific rules and/or policies may represent rules and/or policies designed for particular area(s) of knowledge/application in real-world use cases. The reference data may be used by an AI agent, e.g., in combination with the APIs and/or domain-specific rules and/or policies, to generate an output. Context data 202 may provide specific constraints and capabilities of the target environment in the subsequent generation steps.

In some embodiments, the APIs are sampled to include, e.g., only, state-changing (‘write’) APIs instead of sate-exploring (‘read’) APIs. In some embodiments, the domain-specific policies and/or rules are sampled to ensure compliance with real-world use cases. Task complexity may be influenced by the number of “write” API calls and the associated policy constraints. In some embodiments, the reference data includes sampled domain data, sampled persona, and sampled examples. To ground tasks in realistic domain data without exceeding context limits, domain-specific data is sampled with additional metadata (e.g., cost, time, attributes). The metadata may enhance coverage and enables more creative and diverse task scenarios. Sampled persona may include user persona descriptions sampled to inform the task intent q and inject realistic human qualities and situational context, enhancing diversity for subsequent human-agent interaction simulation. For example, user persona may include a character, an identity, or a role that user adopts or presents. Few-shot examples of well-formed tasks relevant to the sampled APIs may be sampled to guide data generator 204 on structure and format.

A candidate task 206 is generated by a data generator using context data 202. Specifically, context data 202 may be fed into a data generator 204 as the input to generate candidate task 206 as the output. Candidate task 206 may include a configuration that includes: a detailed user intent q describing the high-level intent/instructions of the task (shown as “intent”); a sequence of groundtruth actions agt required to fulfill the intent (shown as “actions”); and expected final outputs o_{gt} to be provided to the user (shown as “outputs”). For example, candidate task 206 may be configured as a tuple of (intent, actions age, outputs o_{gt}). In some embodiments, the data generator 204 is based on an LLM, and can be referred to as a LLM-based data generator.

Candidate task 206 may undergo a format and execution check by a format & execution checker 208, which may include a LLM. A format check may check whether the task configuration is structured correctly, e.g., following required syntax, grammar, schema, etc. In some embodiments, the format check verifies the structural correctness of generated actions (e.g., valid API call formats) and outputs, and confirms the executability of each action in a_{gt} within a simulated target environment E (checking API names, arguments, types). An execution check may check whether the task configuration can be carried out. In some embodiments, the execution check simulates each action a_{gt} in the execution environment, validates API names, argument names, and data types. In some embodiments, the format and execution check further includes a policy compliance check by translating domain-specific policies into Python unit tests. The unit tests may run against the simulated execution trace of a_{gt} to detect violations, especially those arising from interactions between multiple actions. Failures may yield detailed feedback on the specific policy violation.

If passing the format and execution check, candidate task 206 may undergo a semantic review by a review committee 210. In some embodiments, review committee 210 may include one or more LLM reviewers. Review committee 210 may assess quality aspects like the semantic coherence between q and a_{gt}, completeness, and overall task sensibility. Majority voting may be used to achieve a more stable assessment. If the score of majority voting for candidate task 206 is equal to or higher than a threshold score, candidate task 206 is retained as a validated task 214.

If candidate task 206 fails at either the format and execution check or the semantic review (e.g., the score of majority voting lower than the threshold score), a feedback generator 212 may aggregate feedback including failure reasons and reviews from format & execution checker 208 and/or review committee 210, summarize the feedback, and generate an improvement plan. The improvement plan may be provided to data generator 204, which may refine (or regenerate) candidate task 206 in a subsequent iteration. In some embodiments, the feedback loop to refine candidate task 206 may be iterated until candidate task 206 (after refinement) passes the format & execution check and the review. In some embodiments, the feedback loop may be performed up to a predetermined number of times, if candidate task 206 (after refinement) keeps failing the format & execution check and the review after a predetermined number of times, and candidate task 206 may be discarded. If candidate task 206 successfully passes the format & execution check and the review after the refinement, candidate task 206 may be retained as a validated task 214 and may exit the feedback loop. The actions (a_{gt}) of validated task 214 may be regarded as groundtruth actions, and the outputs (o_{gt}) of validated task 214 may be regarded as expected final outputs or groundtruth outputs. Validated task 214 may be a multi-turn task with a tuple of (task intent, groundtruth actions a_{gt}, groundtruth outputs o_{gt}).

This agentic design with feedback loops in task generation pipeline 200 may be important for generating high-quality tasks efficiently. By incorporating reflection and improvement based on validation results, task generation pipeline 200 may learn from failures and progressively generate better tasks.

FIG. 2C shows a multi-turn trajectory generation pipeline 201 as part of multi-turn enhancement framework 250, according to some embodiments. Multi-turn trajectory generation pipeline 201 may perform operations in “Phase 2” of multi-turn enhancement framework 250. For example, Phase 2 may include “Human-Agent environment interaction trajectory collection.” In some embodiments, Phase 2 simulates realistic multi-turn interactions between an LLM-based human user and a test agent in an executable environment. Multi-turn trajectory generation pipeline 201 may be configured to generate a multi-turn training dataset that includes one or more multi-turn trajectories. Multi-turn trajectory generation pipeline 201 may include a simulated user 216 and a test agent 218. Simulated user 216 and test agent 218 may conduct multi-turn conversations that simulate the conversations between a human user and an AI agent. In some embodiments, simulated user 216 and test agent 28 are both based on LLMs.

The task intent q of validated task 214 (with configurations q, a_{gt}, o_{gt}) and a specific persona may be provided to simulated user 216 as an input. In response to receiving task intent q, simulated user 216 may generate a question for test agent 218 to retrieve certain information requested in task intent q. In some embodiments, task intent q may require multi-turn conversation 220 (or multi-turn interactions) between simulated user 216 and test agent 218 for test agent 218 to reach the final output requested by task intent q. Multi-turn conversation 220 may include one or more outputs by simulated use 216 and one or more outputs by test agent 218, forming a multi-turn trajectory. In response to receiving the task intent q, simulated user 216 may generate a first question for test agent 218 based on task intent q. Receiving the first question, test agent 218 may generate a first answer, which causes simulated user 216 to generate a second question or a response. Receiving the second question, test agent 218 may generate a second answer, so on and so forth until test agent 218 reaches the final output. During multi-turn conversation 220, based on the information provided by simulated user 216, test agent 218 may conduct one or more API calls to obtain necessary information for answering simulated user 216. The APIs may include state-changing (“write”) APIs that can modify one or more states in the environment after execution. The APIs are non-conflicting with one another. In some embodiments, during multi-turn conversation 220, simulated human 216 may reveal information or sub-goals incrementally, while test agent 218 may interpret the evolving context interact with the environment via API calls when needed, and respond coherently. In some embodiments, simulated user 216 is unaware of the underlying environment and available APIs that mimic a real-world user.

For example, as shown in FIG. 2C, task intent q may include “help a grumpy customer to return an order”. Simulated user 216 may initiate the conversation by generating the first question that is consistent with task intent q. Test agent 218 may process the first question and request further information from simulated user 216, and may conduct an API call to obtain information (e.g., customer information, order information, etc.) used to generate the second answer. Test agent 218 may interact with the simulation environment using the executable API. For example, the API call may cause a server to execute a piece of code 222 to obtain user information from a database. The execution of the APIs may modify the state (configuration) 224 of the executable environment.

The multi-turn conversation 220 may end if the question of simulated user 216 is answered or a maximum number of exchanges between simulated user 216 and test agent 218 is reached. After the multi-turn conversation 220 is completed, multi-turn trajectory generation pipeline 201 may compare (226) the multi-turn conversation 220 to groundtruth to determine whether multi-turn conversation 220 is a successful trajectory. The comparison may include comparing one or more outputs by test agent 218 to the groundtruth outputs o_{gt} of validated task 214, and/or comparing one or more actions by test agent 218 to the groundtruth actions a_{gt} of validated task 214. In some embodiments, multi-turn trajectory generation pipeline 201 may only compare the final output of test agent 218 to the final output of validated task 214. In some embodiments, the comparing of the actions includes the comparing of change of states in the executable environment caused by the actions of test agent 218 versus that caused by the actions of validated task 214. Depending on the design, if one or more actions by test agent 218 match the groundtruth actions, and/or one or more outputs by test agent 218 match the groundtruth outputs, multi-turn conversation 220 may be considered a successful trajectory 228. This may ensure that interactions are both dynamically plausible and grounded in a correct solution. In some embodiments, if all actions by test agent 218 match the groundtruth actions, and the final output by test agent 218 matches the final output of validated task 214, multi-turn conversation 220 may be a successful trajectory 228. Successful trajectory 228 may be regarded as a training multi-turn conversation, and may be retained in a multi-turn training dataset 230 for training an AI agent.

The two-phase design of multi-turn enhancement framework 250 offers several benefits. First, it provides verifiability by grounding interaction data in pre-validated task configurations. Second, it enhances realism by focusing the simulation on natural turn-by-turn dynamics without the simultaneous burden of task solution generation. Lastly, the modular approach isolates issues in task design from those in conversational modeling, facilitating debugging and scalability across diverse interaction patterns. In essence, by integrating agentic generation of verifiable task “blueprint” with realistic simulation of conversational dynamics, multi-turn enhancement framework 250 produces high-quality, multi-turn interaction data that balances structural correctness with the naturalness required for training agent models.

The multi-turn training dataset 230, including a plurality of multi-turn trajectories generated from Phase 1 and Phase 2 of multi-turn enhancement framework 250, may be used to train an LLM that the AI agent is built on, on multi-turn conversation/interactions. A multi-turn trajectory in multi-turn training dataset 230 may include task intent q and multi-turn conversation 220 (e.g., multiple rounds of interactions between simulated user 216 and test agent 218, as shown in FIG. 2C). The training of the AI agent may include supervised learning. In some embodiments, task intent q and responses by simulated user 216 are provided to the LLM as an input. The LLM may generate an output response given the input. A training objective may be determined by comparing the output response to the interactions by test agent 218 in the multi-turn trajectory (i.e., as the groundtruth). In various embodiments, the training objective includes a loss function (e.g., cross-entropy loss, etc.), and the parameters of the LLM may be updated while the training objective is minimized.

### Computer and Network Environment

FIG. 3A is a simplified diagram illustrating a computing device implementing multi-turn enhancement framework 250 described in FIGS. 2A-2C, according to one embodiment described herein. As shown in FIG. 3A, computing device 300 includes a processor 310 coupled to memory 320. Operation of computing device 300 is controlled by processor 310. And although computing device 300 is shown with only one processor 310, it is understood that processor 310 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 300. Computing device 300 may be implemented as a stand-alone subsystem, as a board added to a computing device, and/or as a virtual machine.

Memory 320 may be used to store software executed by computing device 300 and/or one or more data structures used during operation of computing device 300. Memory 320 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities.

In another embodiment, processor 310 may comprise multiple microprocessors and/or memory 320 may comprise multiple registers and/or other memory elements such that processor 310 and/or memory 320 may be arranged in the form of a hardware-based neural network, as further described in FIG. 3B.

In some examples, memory 320 may include non-transitory, tangible, machine readable media that includes executable code that when run by one or more processors (e.g., processor 310) may cause the one or more processors to perform the methods described in further detail herein. For example, as shown, memory 320 includes instructions for multi-turn enhancement module 330 that may be used to implement and/or emulate the systems and models, and/or to implement any of the methods described further herein. multi-turn enhancement module 330 may receive input 340 such as an input training data (e.g., context data 202) via the data interface 315 and generate an output 350 which may be output response by an AI agent.

The data interface 315 may comprise a communication interface, a user interface (such as a voice input interface, a graphical user interface, and/or the like). For example, the computing device 300 may receive the input 340 (such as a training dataset) from a networked database via a communication interface. Or the computing device 300 may receive the input 340, such as context data 202, from a user via the user interface.

In some embodiments, the multi-turn enhancement module 330 is configured to generate a multi-turn training dataset, and train an AI agent using the multi-turn training dataset. The multi-turn enhancement module 330 may further include a data submodule 331 (e.g., similar to task generation pipeline 200 and multi-turn trajectory generation pipeline 201 in FIGS. 2A-2C). Data submodule 331 may be configured to generate a set of validated tasks 214, and a multi-turn training dataset 230 from the validated tasks 214. Detailed description of the data generation may be referred to the description of FIGS. 2A-2C. AI agent submodule 332 may be configured to train an AI agent using the multi-turn training dataset 230, e.g., using supervised learning. Visualization submodule 333 may be configured to display any results (e.g., validated tasks 214, multi-turn training dataset 230, output response of the AI agent, etc.) generated during the data generation and/or training on a display device.

Some examples of computing devices, such as computing device 300 may include non-transitory, tangible, machine readable media that include executable code that when run by one or more processors (e.g., processor 310) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 3B is a simplified diagram illustrating the neural network structure implementing the multi-turn enhancement module 330 described in FIG. 3A, according to some embodiments. In some embodiments, the multi-turn enhancement module 330 and/or one or more of its submodules 331-333 may be implemented at least partially via an artificial neural network structure shown in FIG. 3B. The neural network comprises a computing system that is built on a collection of connected units or nodes, referred to as neurons (e.g., 344, 345, 346). Neurons are often connected by edges, and an adjustable weight (e.g., 351, 352) is often associated with the edge. The neurons are often aggregated into layers such that different layers may perform different transformations on the respective input and output transformed input data onto the next layer.

For example, the neural network architecture may comprise an input layer 341, one or more hidden layers 342 and an output layer 343. Each layer may comprise a plurality of neurons, and neurons between layers are interconnected according to a specific topology of the neural network topology. The input layer 341 receives the input data (e.g., 340 in FIG. 3A), such as context data 202. The number of nodes (neurons) in the input layer 341 may be determined by the dimensionality of the input data (e.g., the length of a vector of context data 202). Each node in the input layer represents a feature or attribute of the input.

The hidden layers 342 are intermediate layers between the input and output layers of a neural network. It is noted that two hidden layers 342 are shown in FIG. 3B for illustrative purpose only, and any number of hidden layers may be utilized in a neural network structure. Hidden layers 342 may extract and transform the input data through a series of weighted computations and activation functions.

For example, as discussed in FIG. 3A, the multi-turn enhancement module 330 receives an input 340 of context data 202 and transforms the input into an output 350 of output response of an AI agent. To perform the transformation, each neuron receives input signals, performs a weighted sum of the inputs according to weights assigned to each connection (e.g., 351, 352), and then applies an activation function (e.g., 361, 362, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 341 is transformed into rather different values indicative data characteristics corresponding to a task that the neural network structure has been designed to perform.

The output layer 343 is the final layer of the neural network structure. It produces the network's output or prediction based on the computations performed in the preceding layers (e.g., 341, 342). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the multi-turn enhancement module 330 and/or one or more of its submodules 331-333 may comprise the transformative neural network structure of layers of neurons, and weights and activation functions describing the non-linear transformation at each neuron. Such a neural network structure is often implemented on one or more hardware processors 310, such as a graphics processing unit (GPU). An example neural network may be xLAM, GPT-4o, Gemini, Qwen2.5, and/or the like.

In one embodiment, the multi-turn enhancement module 330 and its submodules 331-333 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q, K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the multi-turn enhancement module 330 and its submodules 331-333 may be implemented by hardware, software and/or a combination thereof. For example, the multi-turn enhancement module 330 and its submodules 331-333 may comprise a specific neural network structure implemented and run on various hardware platforms 360, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 360 used to implement the neural network structure is specifically configured based on factors such as the complexity of the neural network, the scale of the tasks (e.g., training time, input data scale, size of training dataset, etc.), and the desired performance.

For example, to deploy the multi-turn enhancement module 330 and its submodules 331-333 and/or any other neural network models such as xLAM, GPT-4o, Gemini, Qwen, etc., described in FIGS. 2A-2C onto hardware platform 360, the neural network based modules 330 and its submodules 331-333 may be optimized for deployment by converting it to a suitable format, such as ONNX or TensorRT, to improve performance and compatibility. Next, depending on the size and workload requirements for modules 330 and its submodules 331-333, hardware types may be chosen for deployment, e.g., processing capacity, GPU memory size, and/or the like. Frameworks and drivers for the chosen hardware 360 frameworks and drivers may thus be installed, such as PyTorch, TensorFlow, or CUDA, to support the hardware platform 360. Then, weights and parameters of the multi-turn enhancement module 330 and its submodules 331-333 may be loaded to the hardware 360. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the multi-turn enhancement module 330 and its submodules 331-333 may be deployed as a service, then they may be integrated with an API endpoint, using tools like Flask, FastAPI, or a cloud platform serverless services, and is accessible by a remote user via a network.

In another embodiment, some or all of layers 341, 342, 343 and/or neurons 342, 345, 346, and operations there between such as activations 361, 362, and/or the like, of the multi-turn enhancement module 330 and its submodules 331-333 may be realized via one or more ASICs. For example, each neuron 342, 345 and 346 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the multi-turn enhancement module 330 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based multi-turn enhancement module 330 and one or more of its submodules 331-333 may be trained by iteratively updating the underlying parameters (e.g., weights 351, 352, etc., bias parameters and/or coefficients in the activation functions 361, 362 associated with neurons) of the neural network based on a loss. For example, during forward propagation, the training data such as context data 202 are fed into the neural network. The data flows through the network's layers 341, 342, with each layer performing computations based on its weights, biases, and activation functions until the output layer 343 produces the network's output 350. In some embodiments, output layer 343 produces an intermediate output on which the network's output 350 is based.

The output generated by the output layer 343 is compared to the expected output (e.g., a “ground-truth” such as the corresponding groundtruth actions, and groundtruth outputs) from the training data, to compute a loss function that measures the discrepancy between the predicted output and the expected output. For example, the loss function may be, e.g., cross entropy, minimum mean squared error (MMSE), or a combination. Given the loss, the negative gradient of the loss function is computed with respect to each weight of each layer individually. Such negative gradient is computed one layer at a time, iteratively backward from the last layer 343 to the input layer 341 of the neural network. These gradients quantify the sensitivity of the network's output to changes in the parameters. The chain rule of calculus is applied to efficiently calculate these gradients by propagating the gradients backward from the output layer 343 to the input layer 341.

In one embodiment, the neural network based multi-turn enhancement module 330 and one or more of its submodules 331-333 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

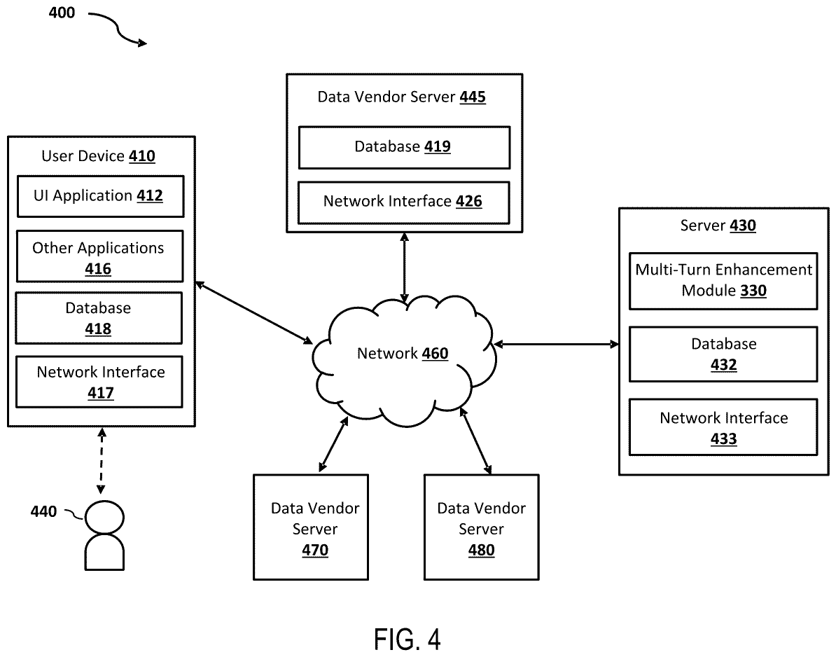

In some embodiments, multi-turn enhancement module 330 and its submodules 331-333 may be housed at a centralized server (e.g., computing device 300) or one or more distributed servers. For example, one or more of multi-turn enhancement module 330 and its submodules 331-333 may be housed at external server(s). The different modules may be communicatively coupled by building one or more connections through application programming interfaces (APIs) for each respective module. Additional network environment for the distributed servers hosting different modules and/or submodules may be discussed in FIG. 4.

During a backward pass, parameters of the neural network are updated backwardly from the last layer to the input layer (backpropagating) based on the computed negative gradient using an optimization algorithm to minimize the loss. The backpropagation from the last layer 343 to the input layer 341 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as asking an AI agent to perform a task that requires multi-turn interactions with a user.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in generative AI.

FIG. 4 is a simplified block diagram of a networked system 400 suitable for implementing multi-turn enhancement framework 250 described in FIGS. 2A-2C, 3A, and 3B and other embodiments described herein. In one embodiment, system 400 includes the user device 410 which may be operated by user 440, data vendor servers 445, 470 and 480, server 430, and other forms of devices, servers, and/or software components that operate to perform various methodologies in accordance with the described embodiments. Exemplary devices and servers may include device, stand-alone, and enterprise-class servers which may be similar to the computing device 300 described in FIG. 3A, operating an OS such as a MICROSOFT® OS, a UNIX® OS, a LINUX® OS, or other suitable device and/or server-based OS. It can be appreciated that the devices and/or servers illustrated in FIG. 4 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 410, data vendor servers 445, 470 and 480, and the server 430 may communicate with each other over a network 460. User device 410 may be utilized by a user 440 (e.g., a driver, a system admin, etc.) to access the various features available for user device 410, which may include processes and/or applications associated with the server 430 to receive an output data anomaly report.

User device 410, data vendor server 445, and the server 430 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 400, and/or accessible over network 460.

User device 410 may be implemented as a communication device that may utilize appropriate hardware and software configured for wired and/or wireless communication with data vendor server 445 and/or the server 430. For example, in one embodiment, user device 410 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 410 of FIG. 4 contains a user interface (UI) application 412, and/or other applications 416, which may correspond to executable processes, procedures, and/or applications with associated hardware. For example, the user device 410 may receive a message indicating context data 202 from the server 430 and display the message via the UI application 412. In other embodiments, user device 410 may include additional or different modules having specialized hardware and/or software as required.

In one embodiment, UI application 412 may communicatively and interactively generate a UI for an AI agent implemented through the multi-turn enhancement module 330 (e.g., an LLM agent) at server 430. In at least one embodiment, a user operating user device 410 may enter a user utterance, e.g., via text or audio input, such as a question, uploading a document, and/or the like via the UI application 412. Such user utterance may be sent to server 430, at which multi-turn enhancement module 330 may generate a response via the process described in FIG. 3A. The multi-turn enhancement module 330 may thus cause a display of output response at UI application 412 and interactively update the display in real time with the user utterance.

In various embodiments, user device 410 includes other applications 416 as may be desired in particular embodiments to provide features to user device 410. For example, other applications 416 may include security applications for implementing client-side security features, programmatic client applications for interfacing with appropriate application programming interfaces (APIs) over network 460, or other types of applications. Other applications 416 may also include communication applications, such as email, texting, voice, social networking, and IM applications that allow a user to send and receive emails, calls, texts, and other notifications through network 460. For example, the other application 416 may be an email or instant messaging application that receives a prediction result message from the server 430. Other applications 416 may include device interfaces and other display modules that may receive input and/or output information. For example, other applications 416 may contain software programs for asset management, executable by a processor, including a graphical user interface (GUI) configured to provide an interface to the user 440 to view the output response.

User device 410 may further include database 418 stored in a transitory and/or non-transitory memory of user device 410, which may store various applications and data and be utilized during execution of various modules of user device 410. Database 418 may store user profile relating to the user 440, predictions previously viewed or saved by the user 440, historical data received from the server 430, and/or the like. In some embodiments, database 418 may be local to user device 410. However, in other embodiments, database 418 may be external to user device 410 and accessible by user device 410, including cloud storage systems and/or databases that are accessible over network 460.

User device 410 includes at least one network interface component 417 adapted to communicate with data vendor server 445 and/or the server 430. In various embodiments, network interface component 417 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 445 may correspond to a server that hosts database 419 to provide training datasets including multi-turn training datasets to the server 430. The database 419 may be implemented by one or more relational database, distributed databases, cloud databases, and/or the like.

The data vendor server 445 includes at least one network interface component 426 adapted to communicate with user device 410 and/or the server 430. In various embodiments, network interface component 426 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 445 may send asset information from the database 419, via the network interface 426, to the server 430.

The server 430 may be housed with the multi-turn enhancement module 330 and its submodules described in FIG. 3A. In some implementations, multi-turn enhancement module 330 may receive data from database 419 at the data vendor server 445 via the network 460 to generate the multi-turn training dataset. The generated multi-turn training dataset may also be sent to the user device 410 for review by the user 440 via the network 460.

In one embodiment, an AI agent implementing the multi-turn enhancement module 330 and its submodules described in FIG. 3A may be built based on an LLM as described in FIG. 3B. For example, the AI agent may be configured with one or more LLMs (e.g., each pretrained for a specific task or domain), a plurality of system prompts, and connected to external APIs to databases and applications (e.g., a search engine, a cloud service, an internal database, etc.).

In some embodiments, the AI agent implementing the multi-turn enhancement module 330 and its submodules described in FIG. 3A may be implemented as a cloud-based AI agent which may be accessed by user device 410 via a chatbot application, a web application, customer support or SaaS applications. In another implementation, a client-side AI agent component may be delivered from the server 430 to user device 410 for local installation such that the client-side AI agent may be installed and runs directly on the user's device. Such local AI agent on the user device 410 may be available offline to adapt to privacy-sensitive applications. In another implementation, the AI agent implementing the multi-turn enhancement module 330 and its submodules described in FIG. 3A may adopt a hybrid cloud and client-based structure to balance computing speed, cost and privacy. For example, a local AI agent may handle basic AI queries locally, but complex queries may be sent to server 430 to process.

The database 432 may be stored in a transitory and/or non-transitory memory of the server 430. In one implementation, the database 432 may store data obtained from the data vendor server 445. In one implementation, the database 432 may store parameters of the multi-turn enhancement module 330. In one implementation, the database 432 may store previously generated multi-turn training datasets and/or validated tasks, and the corresponding input feature vectors.

In some embodiments, database 432 may be local to the server 430. However, in other embodiments, database 432 may be external to the server 430 and accessible by the server 430, including cloud storage systems and/or databases that are accessible over network 460.

The server 430 includes at least one network interface component 433 adapted to communicate with user device 410 and/or data vendor servers 445, 470 or 480 over network 460. In various embodiments, network interface component 433 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 460 may be implemented as a single network or a combination of multiple networks. For example, in various embodiments, network 460 may include the Internet or one or more intranets, landline networks, wireless networks, and/or other appropriate types of networks. Thus, network 460 may correspond to small scale communication networks, such as a private or local area network, or a larger scale network, such as a wide area network or the Internet, accessible by the various components of system 400.

### Example Work Flows

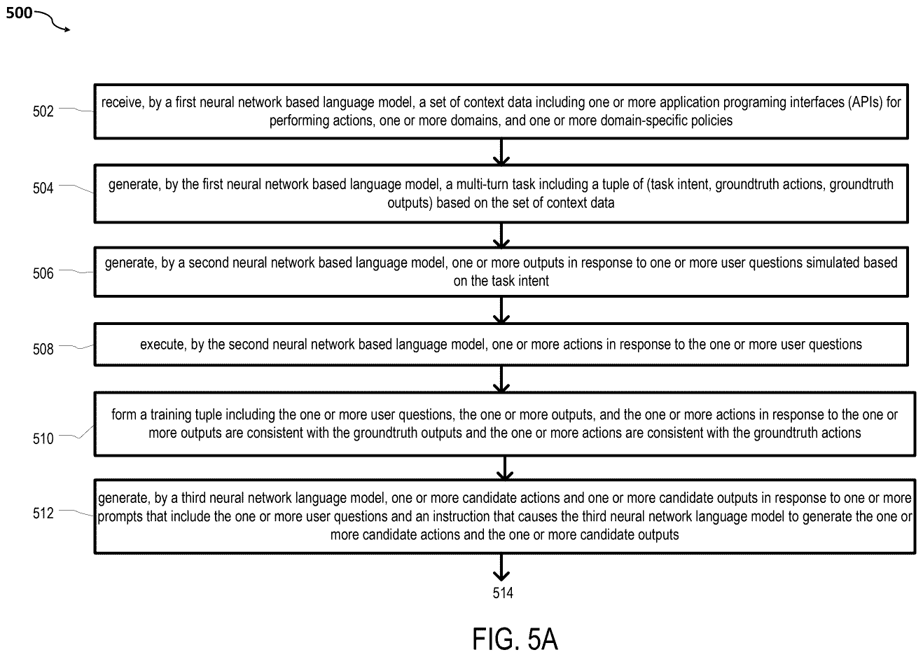

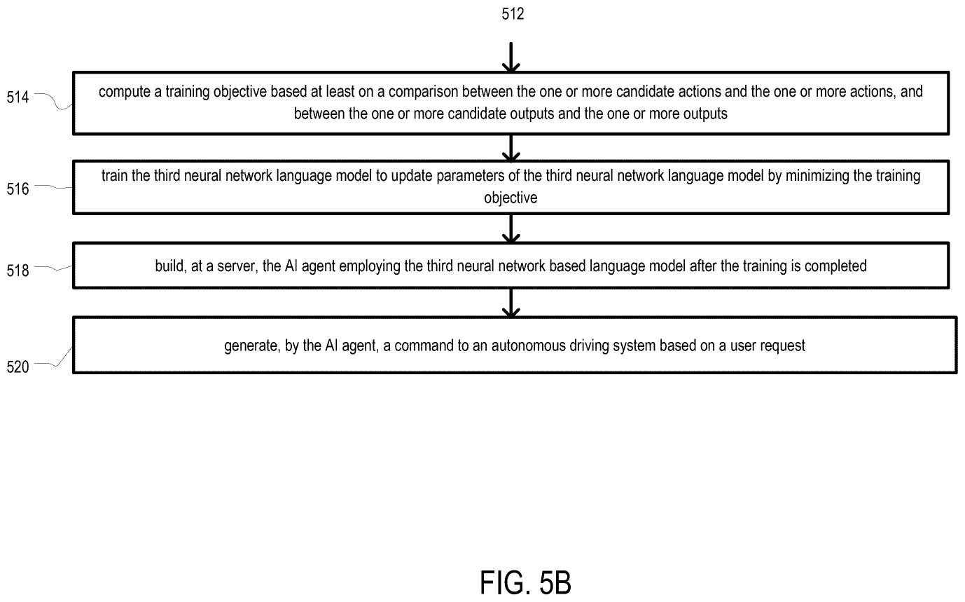

FIG. 5 is an example logic flow diagram illustrating a method for multi-turn generation by an AI agent based on the framework shown in FIGS. 2A-2C, according to some embodiments described herein. One or more of the processes of method 500 may be implemented, at least in part, in the form of executable code stored on non-transitory, tangible, machine-readable media that when run by one or more processors may cause the one or more processors to perform one or more of the processes. In some embodiments, method 500 corresponds to the operation of the multi-turn enhancement module 330 (e.g., FIGS. 3A and 4) that performs generating multi-turn training dataset and training an LLM with the multi-turn training dataset.

In some embodiments, method 500 is performed by a system such as computing device 300, user device 410, server 430, or another device or combination of devices. Inputs (e.g., context data 202) may be received via a data interface such as data interface 315, network interface 417, network interface 433, or via a data interface that is integrated with a device. For example UI Application 412 may receive user inputs via a text input interface (e.g., keyboard), audio input (e.g., microphone), video interface (e.g., camera), or other interface for receiving user inputs (e.g., a mouse or touch display).

As illustrated, the method 500 includes a number of enumerated steps, but aspects of the method 500 may include additional steps before, after, and in between the enumerated steps. In some aspects, one or more of the enumerated steps may be omitted or performed in a different order.

At step 502, a set of context data is received by a first neural network based language model. The set of context data includes one or more application programing interfaces (APIs) for performing actions, one or more domains, and one or more domain-specific policies. In some embodiments, the one or more APIs include write APIs configured to modify a state of an executable environment and are non-conflicting with one another.

At step 504, a multi-turn task including a tuple of (task intent, groundtruth actions, groundtruth outputs) is generated by the first neural network based language model, based on the set of context data.

At step 506, one or more outputs is generated by a second neural network based language model in response to one or more user questions simulated based on the task intent. In some embodiments, the one or more outputs end in response to: the one or more user questions being answered, or a maximum number of exchanges between the one or more user questions and the one or more outputs being reached. In some embodiments, the one or more outputs are consistent with the groundtruth outputs in response to a final one of the one or more outputs being same as a final one of the groundtruth outputs

At step 508, one or more actions are executed by the second neural network based language model in response to the one or more user questions. In some embodiments, the executing of the one or more actions includes conducting an API call that modifies a state of an executable environment. In some embodiments, the forming of the training tuple includes comparing a first state modified to the executable environment by the one or more actions to a second state modified to the executable environment by the groundtruth actions; and the one or more actions are consistent with the groundtruth actions in response to the first state being same as the second state.

At step 510, a training tuple is formed including the one or more user questions, the one or more outputs, and the one or more actions in response to the one or more outputs are consistent with the groundtruth outputs and the one or more actions are consistent with the groundtruth actions.

At step 512, one or more candidate actions and one or more candidate outputs are generated by a third neural network language model in response to one or more prompts that include the one or more user questions and an instruction that causes the third neural network language model to generate the one or more candidate actions and the one or more candidate outputs.

At step 514, a training objective is computed based at least on a comparison between the one or more candidate actions and the one or more actions, and between the one or more candidate outputs and the one or more outputs;

At step 516, the third neural network language model is trained to update parameters of the third neural network language model by minimizing the training objective.

At step 518, the AI agent employing the third neural network based language model is built at a server, after the training is completed.

At step 520, a command to an autonomous driving system is generated by the AI agent based on a user request.

In some embodiments, the method 500 further includes conducting, by a fourth neural network based language model, at least one of a format check or an execution check on the multi-turn task before sending the multi-turn task to the second neural network based language model. In some embodiments, the method 500 further includes, in response to the multi-turn task fails the format check or the execution check, generating, by a fifth neural network based language model, an improvement plan for the multi-turn task based on feedback from the fourth neural network based language model; and refining, by the first neural network based language model, the multi-turn task based on the improvement plan.

In some embodiments, the method 500 further includes conducting, by a committee of a plurality of sixth neural network based language models, a semantic evaluation on the multi-turn task using majority voting.

In some embodiments, method 500 is applicable in a variety of applications. For example, the task request received by a neural network model (e.g., GPT-4o) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 500, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method 500 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

### Example Results

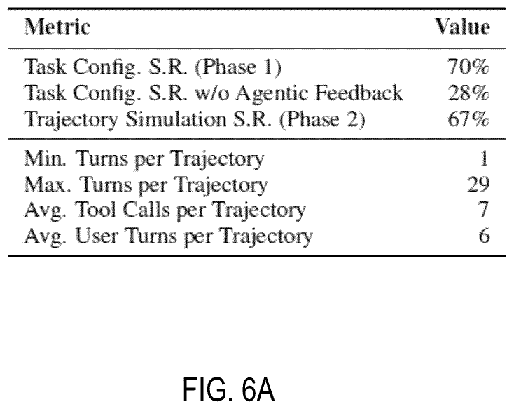

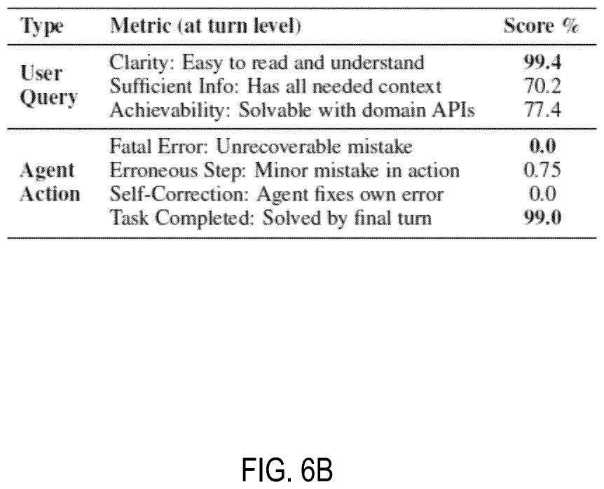

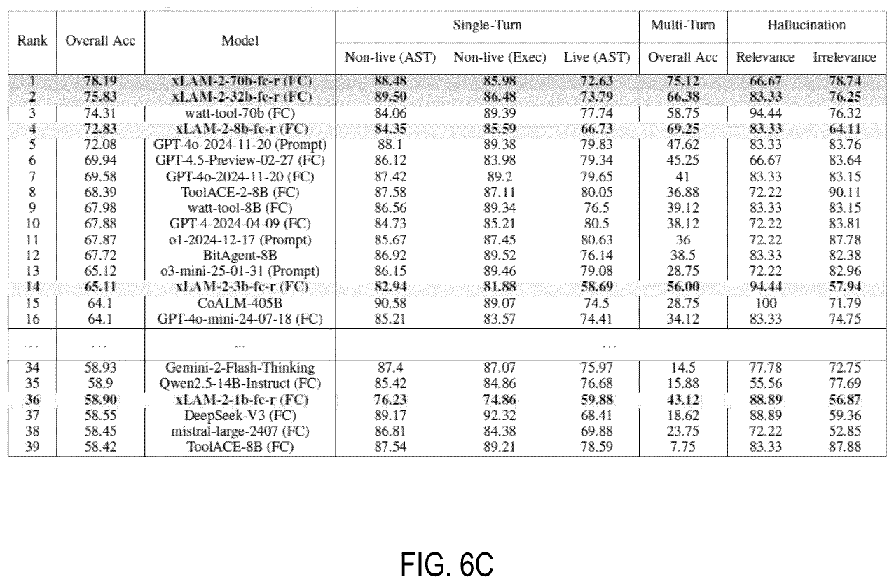

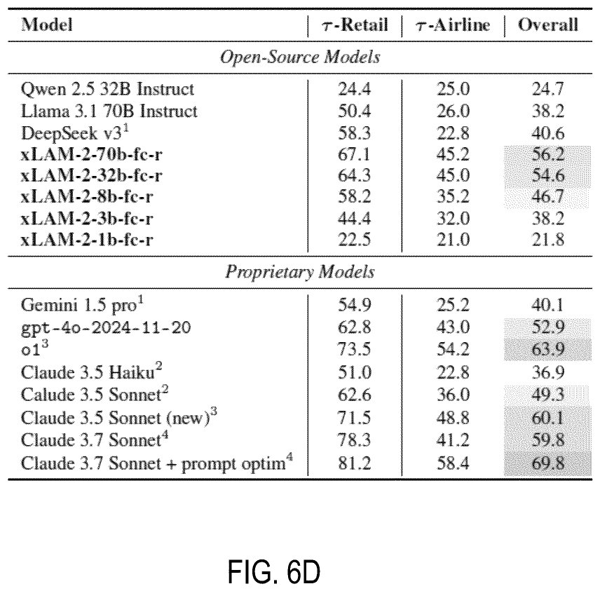

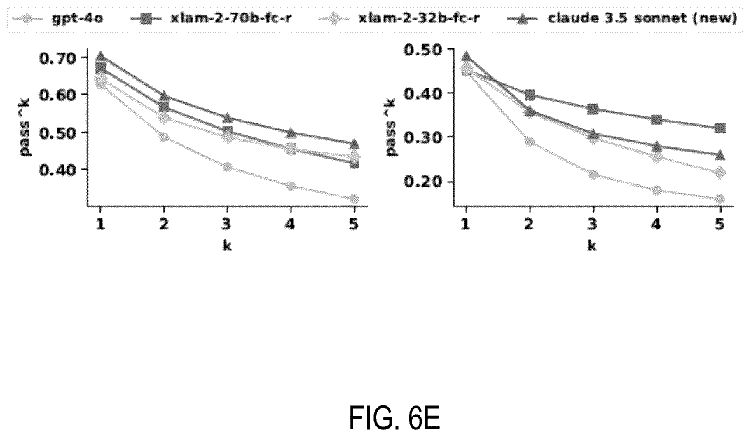

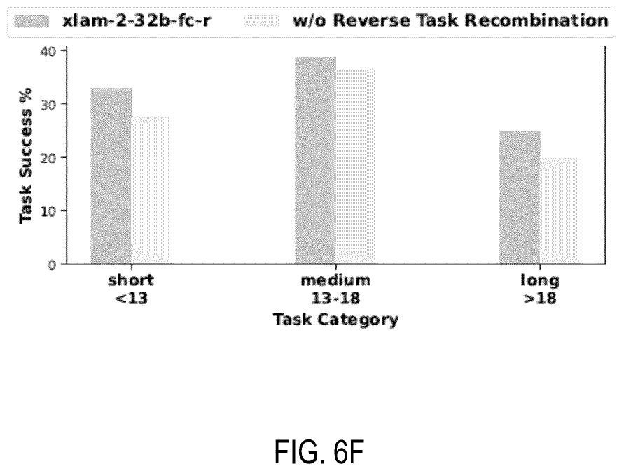

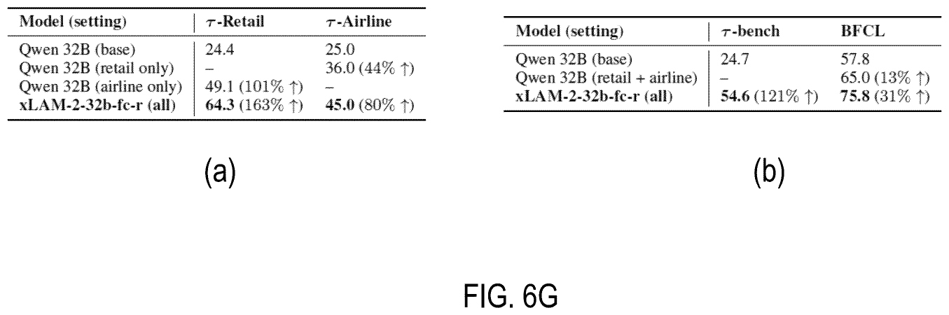

FIGS. 6A-6G represent exemplary test results using embodiments described herein. APIGen-MT is an example implementation of the disclosed multi-turn enhancement framework 250.

Phase 1: Implementation: Task Configuration Generation and Validation API Dependency Graph and Context Samplers are described herein.

Generating realistic tasks for τ-bench requires navigating its specific APIs, policies, and data structures. The following techniques are implemented for task generation and validation.

API Graph Modeling. The available APIs in each τ-bench domain are modeled as a directed graph, where nodes represent APIs and edges represent dependencies between them. An edge exists from API A to API B if B's input arguments can depend on A's output and the co-occurrence of this tool-call pair is permitted under domain policies. This graph-based approach enables us to generate realistic task sequences by performing random walks through the API dependency graph.

Specialized Context Samplers. To ensure task diversity, realism, and grounding, several domain-specific samplers that provide context to the LLM-based task generator are used.

API Sampler: state-exploring (‘read’) APIs and state-changing (‘write’) APIs which can modify the environment states are distinguished each other. The generator focuses on sampling the necessary ‘write’ APIs to form the core of a_{gt}, allowing flexibility in how ‘read’ APIs might be used during the subsequent interaction phase.

Policy Sampler: domain-specific policies and rules are sampled. These policies are incorporated into the task generation to ensure compliance of real-world use cases. Task complexity is influenced by the number of ‘write’ calls and the associated policy constraints.

Domain Data Sampler: To ground tasks in realistic domain data without exceeding context limits, domain-specific data with additional metadata (e.g., cost, time, attributes) is sampled. This metadata enhances coverage and enables more creative and diverse task scenarios.

Persona Sampler: user persona descriptions from PersonaHub (T. Ge, X. Chan, X. Wang, D. Yu, H. Mi, and D. Yu. Scaling synthetic data creation with 1,000,000,000 personas, 2024. URL https://arxiv.org/abs/2406. 20094.) is incorporated to inform the user intent q and inject realistic human qualities and situational context, enhancing diversity for subsequent Phase 2 human-agent interaction simulation.

Example Sampler: few-shot examples of well-formed tasks relevant to the sampled APIs are provided, guiding the generator on structure and format.

For each task generation iteration, the sampling frequency for each sampler is randomly varied to enhance diversity and prevent repetitive scenarios. The sampled information is compiled into a prompt instructing the LLM generator to produce a <thought> (its reasoning), the user <intent> (q), the corresponding groundtruth <actions> (a_{g}t), and the expected final <outputs> (o_{g}c).

### Multi-Stage Validation for T-Bench

### Stage 1: Action Validation.

Format Check verifies the presence and basic structure of required task components (<thought>, <intent>, <actions>, <outputs>) and ensures all tool calls in <actions> are valid JSON and outputs in <outputs> are strings.

Execution Check simulates each action in a_{gt} within the τ-bench environment, validating API names, argument names, and data types. The cumulative effect on the environment state ΔS_{E} is captured as a diff_patch, similar to git diff.

Policy Compliance Check leverages the executable nature of τ-bench by translating domain policies into Python unit tests. These tests run against the simulated execution trace of a_{gt} to detect violations, especially those arising from interactions between multiple actions. Failures yield detailed feedback on the specific policy violation.

Stage 2: Alignment Validation. Tasks successfully passing Stage 1's action validation are then assessed for semantic alignment Specifically, whether the groundtruth actions (a_{gt}), as reflected by their environmental effects summarized in the diff_patch, accurately and comprehensively fulfill the user's intent expressed in the instruction (q), is evaluated. To mitigate the potential biases and inconsistencies of a single evaluator, a committee of diverse LLM judges (K. Zhang, W. Yao, Z. Liu, Y. Feng, Z. Liu, R. Rithesh, T. Lan, L. Li, R. Lou, J. Xu, et al. Diversity empowers intelligence: Integrating expertise of software engineering agents. In The Thirteenth International Conference on Learning Representations, 2024; Z. Bi, K. Han, C. Liu, Y. Tang, and Y. Wang. Forest-of-thought: Scaling test-time compute for enhancing llm reasoning. arXiv preprint arXiv:2412.09078, 2024.) is employed. These judges review each task based on a systematic rubric with metrics such as Correctness, Completeness, Satisfaction, and Creativity. Each judge provides scores and qualitative feedback. A majority voting strategy is used across the committee's judgments to determine the final assessment for each metric and the overall task quality. This approach yields more stable and reliable evaluation results compared to single-judge assessments.

Stage 3: Final Semantic Review & Refinement. Based on the aggregated scores from the committee (determined via majority voting), tasks achieving an average score above a predefined threshold are accepted and added to the pool of validated task configurations. Failing tasks trigger the feedback loop mechanism. Consolidated feedback, summarizing the points raised by the committee majority, is sent back to the LLM task generator. This initiates a reflection process (N. Shinn, F. Cassano, A. Gopinath, K. R. Narasimhan, and S. Yao. Reflexion: language agents with verbal reinforcement learning. In Thirty-seventh Conference on Neural Information Processing Systems, 2023.), guiding the generator to revise the task in the subsequent iteration to address the identified shortcomings.

Reverse Task Recombination for Complex Task Construction is described.

While the refinement process improves generation quality and efficiency, directly generating complex, long-horizon tasks remains challenging. Validation failures can occur due to subtle policy conflicts or difficulties in ensuring perfect alignment across many steps. To overcome this and systematically construct more complicated scenarios, Reverse Task Recombination, a technique that leverages the principle of compositionality (M. Chen, sunhaoze, T. Li, F Yang, H. Liang, KeerLu, B. CUI, W. Zhang, Z. Zhou, and weipeng chen. Facilitating multi-turn function calling for LLMs via compositional instruction tuning. In The Thirteenth International Conference on Learning Representations, 2025; S. A. Hayati, T. Jung, T. Bodding-Long, S. Kar, A. Sethy, J.-K. Kim, and D. Kang. Chain-of-instructions: Compositional instruction tuning on large language models. arXiv preprint arXiv:2402.11532, 2024.), is implemented, similar to modular design in software engineering. The core idea is to build complex tasks from simpler, independently validated “building blocks”:

Select Validated Tasks: Identify multiple simpler tasks (T1, T2, . . . ) that have successfully passed all validation stages (Stages 1-3) and are associated with the same user persona.

Concatenate Components: Combine their respective groundtruth actions a_{combined}=a_{gt,1}ºa_{gt,2}º . . . ) and expected outputs (o_{combined}=o_{gt,1}⊕o_{gt,2}⊕ . . . , where º denotes action sequence concatenation and e denotes output aggregation).

Re-Check Policy Compliance: Rerun Policy Check on a_{combined} to ensure that the cumulative action sequence remains logically sound and adheres to the domain rules as combinations could cause conflicting actions to appear together, for e.g., returning and canceling the same order.

Synthesize Combined Intent: Instruct the generator to create a new coherent user instruction (q_{combined}) that logically integrates the goals and steps represented by a_{combined} and o_{combined}. This new instruction should frame the combined actions as a single, more complex user request.

Re-Validate Semantics: Submit the newly formed complex task Tcombined={q_{combined}, a_{combined}, o_{combined}} for validation starting from Stage 2 (Alignment Validation). Stage 1 (Action Validation) can be safely skipped for a_{combined} because each constituent action sequence (agt,1, agt,2, . . . ) has already been individually checked for format and execution within its original context, and policy compliance in the current context. Stage 3 (Final Semantic Review) proceeds based on the outcome of Stage 2 for the combined task.

This method allows for the generation of complex, multi-step tasks reliably, as it builds upon verified components while focusing the validation effort on the semantic coherence of the combined whole.

### Phase 2: Simulated Human-Agent Interplay for Trajectory Collection

Building on the verified tasks from Phase 1—which include a detailed user intent q, groundtruth actions a_{gt}, and expected outputs o_{gt}—multi-turn interaction trajectories between an agent (A) and a human user (H) modeled by an LLM are simulated. Guided by the instruction q and an associated persona, the simulated human incrementally reveals task details to mimic realistic interactions. The agent, instantiated as GPT-4o with its function-calling mode, interprets the evolving intent and executes the necessary actions to complete the task. A critical challenge is maintaining its stability and fidelity. A Best-of-N (BoN) with self-critique mechanism (more details in Appendix § B.1) is implemented to combat this and validate its effectiveness on the τ-bench test set. It is observed improved success rate (6% ↑) and reduced variance (3%↓). Rejection sampling is used to retain only successful trajectories (r=1), verified by matching the final environment state to a_{gt} and agent responses to o_{gt}. Each task is attempted up to three times, and all unique successful runs are aggregated into an offline dataset for downstream use.

APIs (5‘read’ and 13‘write’) are sourced. The APIs are implemented as Python functions and domain rules from the Retail and Airline environments of τ-bench. GPT-4o and DeepSeek V3 models are used in the task generation, validation and agent-human interplay stages to collect training data. The maximum number of reflection-based feedback turns is set to 3 for retail and 5 for airline respectively.

A summary of the data collection is shown in FIG. 6A. Long trajectories may be collected using a strong model like gpt-4o to take an average 12 turns to complete the task using APIGen-MT. The agentic pipeline involving review committee and iterative refinement via reflection provides a 2.5× boost to the task collection success rate to attain 70%. This demonstrates that APIGen-MT can reliably generate high-quality, multi-turn data in complex domains with strict policy constraints, enabling the creation of diverse, realistic, and verifiable datasets for training and evaluation of conversational agents.

To evaluate the quality and realism of data generated, an expert review of 220 sampled trajectories from the τ-bench dataset is conducted. As shown in FIG. 6B, the data reflects high quality across both task query and trajectory dimensions. 99.4% of queries were deemed clearly understandable, and the agent successfully completed the task in 99% of cases, with zero fatal errors and a low erroneous turn rate (0.75%). The sufficiency and achievability rates are naturally lower and improve over the turns as user intent is gradually revealed.

Filtered Behavioral Cloning (BC) is performed using the collected trajectories with Llama 3.1/3.2 Instruct models (A. Dubey, A. Jauhri, A. Pandey, A. Kadian, A. Al-Dahle, A. Letman, A. Mathur, A. Schelten, A. Yang, A. Fan, et al. The llama 3 herd of models. arXiv preprint arXiv:2407.21783, 2024.) and Qwen 2.5 Instruct models (Qwen, :, A. Yang, B. Yang, B. Zhang, B. Hui, B. Zheng, B. Yu, C. Li, D. Liu, F Huang, H. Wei, H. Lin, J. Yang, J. Tu, J. Zhang, J. Yang, J. Yang, J. Thou, J. Lin, K. Dang, K. Lu, K. Bao, K. Yang, L. Yu, M. Li, M. Xue, P. Zhang, Q. Zhu, R. Men, R. Lin, T. Li, T. Tang, T. Xia, X. Ren, X. Ren, Y. Fan, Y. Su, Y. Zhang, Y. Wan, Y. Liu, Z. Cui, Z. Zhang, and Z. Qiu. Qwen2.5 technical report, 2025.). Two challenging benchmarks designed specifically for assessing agent capabilities are evaluated. The two benchmarks focus on multi-turn interactions and tool use capabilities, which are central to our data generation methodology—(1) BFCL v3 (F. Yan, H. Mao, C. C.-J. Ji, T. Zhang, S. G. Patil, I. Stoica, and J. E. Gonzalez. Berkeley function calling leaderboard. 2024.), a leading benchmark for tool-use evaluation, specifically designed to assess LLMs' function calling capabilities and (2) τ-bench (S. Yao, N. Shinn, P. Razavi, and K. Narasimhan. Tau-bench: A benchmark for tool-agent-user interaction in real-world domains. arXiv preprint arXiv:2406.12045, 2024.), a comprehensive benchmark for evaluating AI agents in realistic scenarios.

The models trained using the synthetic training dataset of the present disclosure demonstrate exceptional performance on the BFCL v3 benchmark. As shown in FIG. 6C, xLAM-2-70b-fc-r and xLAM-2-32b-fc-r top the leaderboard with overall accuracies of 78.19% and 75.83%, outperforming all proprietary and open-source models. The most striking advantage appears in multi-turn scenarios, where the disclosed models excel across all parameter scales: xLAM-2-70b-fc-r achieves 75.12% accuracy, while smaller models also excel—xLAM-2-8b-fc-r at 69.25%, xLAM-2-3b-fc-r at 56.00%, and xLAM-2-1b-fc-r at 43.12%—all significantly ahead of o1 (36%) and GPT-4o (41%) in function-calling mode. Additionally, the disclosed models demonstrate strong hallucination detection, with xLAM-2-3b-fc-r achieving 94.44% on relevance detection, matching the best score in this category.

FIG. 6D presents results under the default naive user setting on τ-bench. The disclosed xLAM-2-70b-fc-r model achieves a 56.2% success rate, outperforming Llama 3.1 70B Instruct (38.2%), DeepSeek v3 (40.6%), and even proprietary models like GPT-4o (52.9%), while approaching more recent models like Claude 3.5 Sonnet (60.1%). Notably, the smaller variants like xLAM-2-32b-fc-r (54.6%) and xLAM-2-8b-fc-r (46.7%) surpass larger baselines, demonstrating that our synthetic data approach enables efficient knowledge transfer and strong performance with fewer parameters.

These results demonstrate that the disclosed APIGen-MT approach—using simulated agent-human interplay to generate multi-turn data—is highly effective. Models trained on this data consistently outperform open-source baselines and rival proprietary models, with especially strong multiturn performance. Notably, it enables smaller models to match or exceed the performance of much larger ones, underscoring the efficiency of our method.

The pass\hat{ }k curves (S. Yao, N. Shinn, P. Razavi, and K. Narasimhan. Tau-bench: A benchmark for tool-agent-user interaction in real-world domains. arXiv preprint arXiv:2406.12045, 2024.) are plotted in FIG. 6E on τ-bench using the default naive user LM setting. pass\hat{ }k measures the probability that all k i.i.d. task trials succeed, averaged across tasks. As k increases, models trained using the synthetic training dataset of the present disclosure show a smaller drop in success rate (SR). Notably, on the more complex airline domain, xLAM-2-70b-fc-r achieves a higher pass\hat{ }5 than Claude, despite a slightly lower pass·1—indicating greater reliability and consistency across trials. This is crucial for real-world deployment, where consistent performance is essential.

Reverse Task Recombination is used to synthesize denser task instructions requiring more interaction turns by combining the intents of individual successful tasks. This allows to study the effect of having complex tasks producing more granular trajectories. A 32B model is trained without data from Reverse Task Recombination, thereby comprising majorly of short trajectories, but maintain the number of trajectories same as the original setup to control for confounding factors related to scale. The tasks are categorized into ‘short’, ‘medium’ and ‘long’ based on the number of turns Claude 3.5 requires to solve them across the union of 8 trials, using the 33rd and 66th percentiles as thresholds. FIG. 6F clearly illustrates how performance drops across all categories suggesting the importance of having diverse length trajectories. The effect is more pronounced in the Airline domain (45%→33%) than in Retail (64%→61%).

Domains where the assistant interacts with a simulated human turn-wise, invoking APIs to fulfill user intent while following policy constraints, are considered in-domain; this includes the Retail and Airline settings from τ-bench. In contrast, BFCL is considered out-of-distribution relative to r-bench, with a broader scope spanning 8 domains. As shown in FIG. 6G, while filtered BC benefits generalization, synthesizing interaction trajectories for specific domains remains essential for achieving better performance. This highlights the importance of a flexible approach like APIGen-MT, which can generate domain-specific data given any environment configuration.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method for multi-turn generation by an artificial intelligence (AI) agent, comprising:
receiving, by a first neural network based language model, a set of context data including one or more application programing interfaces (APIs) for performing actions, one or more domains, and one or more domain-specific policies;
generating, by the first neural network based language model, a multi-turn task including a tuple of (task intent, groundtruth actions, groundtruth outputs) based on the set of context data;
generating, by a second neural network based language model, one or more outputs in response to one or more user questions simulated based on the task intent;
executing, by the second neural network based language model, one or more actions in response to the one or more user questions;
forming a training tuple including the one or more user questions, the one or more outputs, and the one or more actions in response to the one or more outputs are consistent with the groundtruth outputs and the one or more actions are consistent with the groundtruth actions;
generating, by a third neural network language model, one or more candidate actions and one or more candidate outputs in response to one or more prompts that include the one or more user questions and an instruction that causes the third neural network language model to generate the one or more candidate actions and the one or more candidate outputs;
computing a training objective based at least on a comparison between the one or more candidate actions and the one or more actions, and between the one or more candidate outputs and the one or more outputs;
training the third neural network language model to update parameters of the third neural network language model by minimizing the training objective;
building, at a server, the AI agent employing the third neural network based language model after the training is completed; and
generating, by the AI agent, a command to an autonomous driving system based on a user request.

2. The method of claim 1, further comprising, conducting, by a fourth neural network based language model, at least one of a format check or an execution check on the multi-turn task before sending the multi-turn task to the second neural network based language model.

3. The method of claim 2, further comprising:
in response to the multi-turn task fails the format check or the execution check, generating, by a fifth neural network based language model, an improvement plan for the multi-turn task based on feedback from the fourth neural network based language model; and
refining, by the first neural network based language model, the multi-turn task based on the improvement plan.

4. The method of claim 1, further comprising, conducting, by a committee of a plurality of sixth neural network based language models, a semantic evaluation on the multi-turn task using majority voting.

5. The method of claim 1, wherein the one or more outputs end in response to: the one or more user questions being answered, or a maximum number of exchanges between the one or more user questions and the one or more outputs being reached.

6. The method of claim 1, wherein the executing of the one or more actions includes conducting an API call that modifies a state of an executable environment.

7. The method of claim 6, wherein:
the forming of the training tuple includes comparing a first state modified to the executable environment by the one or more actions to a second state modified to the executable environment by the groundtruth actions; and
the one or more actions are consistent with the groundtruth actions in response to the first state being same as the second state.

8. The method of claim 1, wherein the one or more outputs are consistent with the groundtruth outputs in response to a final one of the one or more outputs being same as a final one of the groundtruth outputs.

9. The method of claim 1, wherein the one or more APIs include write APIs configured to modify a state of an executable environment and are non-conflicting with one another.

10. A system for multi-turn generation by an artificial intelligence (AI) agent, the system comprising:
a memory that stores a first neural network based language model, a second neural network based language model, a third neural network based language model, and a plurality of processor executable instructions;
a communication interface that receives a set of context data including one or more application programing interfaces (APIs) for performing actions, one or more domains, and one or more domain-specific policies; and
one or more hardware processors that read and execute the plurality of processor-executable instructions from the memory, wherein the plurality of processor-executable instructions are configurable to cause the system to perform operations comprising:
receiving, by the first neural network based language model, the set of context data, the one or more domains, and the one or more domain-specific policies;
generating, by the first neural network based language model, a multi-turn task including a tuple of (task intent, groundtruth actions, groundtruth outputs) based on the set of context data;
generating, by the second neural network based language model, one or more outputs in response to one or more user questions simulated based on the task intent;
executing, by the second neural network based language model, one or more actions in response to the one or more user questions;
forming a training tuple including the one or more user questions, the one or more outputs, and the one or more actions in response to the one or more outputs are consistent with the groundtruth outputs and the one or more actions are consistent with the groundtruth actions;
generating, by the third neural network language model, one or more candidate actions and one or more candidate outputs in response to one or more prompts that include the one or more user questions and an instruction that causes the third neural network language model to generate the one or more candidate actions and the one or more candidate outputs;
computing a training objective based at least on a comparison between the one or more candidate actions and the one or more actions, and between the one or more candidate outputs and the one or more outputs;
training the third neural network language model to update parameters of the third neural network language model by minimizing the training objective;
building, at a server, the AI agent employing the third neural network based language model after the training is completed; and
generating, by the AI agent, a command to an autonomous driving system based on a user request.

11. The system of claim 10, wherein the operations further include, conducting, by a fourth neural network based language model, at least one of a format check or an execution check on the multi-turn task before sending the multi-turn task to the second neural network based language model.

12. The system of claim 11, wherein the operations further include:
in response to the multi-turn task fails the format check or the execution check, generating, by a fifth neural network based language model, an improvement plan for the multi-turn task based on feedback from the fourth neural network based language model; and
refining, by the first neural network based language model, the multi-turn task based on the improvement plan.

13. The system of claim 10, wherein the operations further include, conducting, by a committee of a plurality of sixth neural network based language models, a semantic evaluation on the multi-turn task using majority voting.

14. The system of claim 10, wherein the one or more outputs end in response to: the one or more user questions being answered, or a maximum number of exchanges between the one or more user questions and the one or more outputs being reached.

15. The system of claim 10, wherein the executing of the one or more actions includes conducting an API call that modifies a state of an executable environment.

16. The system of claim 15, wherein:
the forming of the training tuple includes comparing a first state modified to the executable environment by the one or more actions to a second state modified to the executable environment by the groundtruth actions; and
the one or more actions are consistent with the groundtruth actions in response to the first state being same as the second state.

17. The system of claim 10, wherein the one or more outputs are consistent with the groundtruth outputs in response to a final one of the one or more outputs being same as a final one of the groundtruth outputs.

18. The system of claim 10, wherein the one or more APIs include write APIs configured to modify a state of an executable environment and are non-conflicting with one another.

19. A non-transitory machine-readable medium comprising a plurality of instructions, executable by one or more processors, wherein the plurality of instructions are configurable to cause the one or more processors to perform operations comprising:
receiving, by a first neural network based language model, a set of context data including one or more application programing interfaces (APIs) for performing actions, one or more domains, and one or more domain-specific policies;
generating, by the first neural network based language model, a multi-turn task including a tuple of (task intent, groundtruth actions, groundtruth outputs) based on the set of context data;
generating, by a second neural network based language model, one or more outputs in response to one or more user questions simulated based on the task intent;
executing, by the second neural network based language model, one or more actions in response to the one or more user questions;
forming a training tuple including the one or more user questions, the one or more outputs, and the one or more actions in response to the one or more outputs are consistent with the groundtruth outputs and the one or more actions are consistent with the groundtruth actions;
generating, by a third neural network language model, one or more candidate actions and one or more candidate outputs in response to one or more prompts that include the one or more user questions and an instruction that causes the third neural network language model to generate the one or more candidate actions and the one or more candidate outputs;
computing a training objective based at least on a comparison between the one or more candidate actions and the one or more actions, and between the one or more candidate outputs and the one or more outputs;
training the third neural network language model to update parameters of the third neural network language model by minimizing the training objective;
building, at a server, the AI agent employing the third neural network based language model after the training is completed; and
generating, by the AI agent, a command to an autonomous driving system based on a user request.

20. The non-transitory machine-readable medium of claim 19, wherein the operations further include, conducting, by a fourth neural network based language model, at least one of a format check or an execution check on the multi-turn task before sending the multi-turn task to the second neural network based language model.
